(19) United States
(12) Patent Application Publication
(10) Pub. No.: US 2016/0089954 A1
(43) Pub. Date: Mar. 31, 2016

(54) SYSTEM AND METHOD FOR SETTING AN ENVIRONMENTAL CONDITION IN OR AROUND A VEHICLE IN RESPONSE TO A DETERMINED MOOD

(71) Applicant: CONTINENTAL AUTOMOTIVE SYSTEMS INC., Auburn Hills, MI (US)

(72) Inventor: LUIS GERARDO ROJAS VILLANUEVA, ZAPOPAN (MX)

(21) Appl. No.: 14/501,369

(22) Filed: Sep. 30, 2014

(51) Int. Cl. B60H 1/00; G01C 21/34; B60Q 3/00

(52) U.S. Cl. CPC B60H 1/00742; B60Q 3/00; G01C 21/34

(57) ABSTRACT

A system and a corresponding method are provided for setting at least one environmental condition in or around a vehicle in response to a mood. A sensor system senses at least one physical property indicative of a mood of at least one occupant in the vehicle and outputs a sensor signal with information regarding the physical property. At least one component is configured for providing an environmental condition, such as, lighting, temperature, sound, or aroma in the vehicle. A control system determines the mood by analyzing the sensor signal from the sensor system. The control system sets the environmental condition provided by the component dependent on the determined mood. The environmental conditions can be set outside the vehicle by suggesting an appropriate travel route dependent on the mood. A safety device can limit the maximum speed of the vehicle dependent on the determined mood.

### BACKGROUND OF THE INVENTION

1. Field of the Invention

The invention relates to setting the environmental conditions in the interior of a vehicle and/or around the vehicle in accordance with the mood of the occupant or occupants of a vehicle.

2. Description of the Related Art

Various methods and systems are known for determining the mood of a person. For example, Published U.S. Patent Application Publication 2012/0130196 A1 to Jain et al. discloses a sensor for determining the mood of a person.

### BRIEF SUMMARY OF THE INVENTION

It is an object of the invention to determine the mood of one or more occupants in a vehicle and to set one or more environmental conditions in the interior of the vehicle in dependence on the determined mood or moods of one or more occupants in the vehicle.

It is another object of the invention to set the environmental conditions in the area through which the vehicle will be driven in dependence on the determined mood or moods. This is accomplished by appropriately choosing the route through which the vehicle will travel.

It is an additional object of the invention to activate a safety device in the vehicle dependent on the determined mood of an occupants in the vehicle, in particular, on the mood of the driver.

With the foregoing and other objects in view there is provided, in accordance with the invention, a system for setting at least one environmental condition in or around a vehicle in response to a mood. The system includes a sensor system configured for sensing at least one physical property indicative of a mood of at least one occupant in the vehicle and for outputting a sensor signal with information regarding one or more physical properties that have been sensed. At least one component is configured for providing an environmental condition in the vehicle. A control system is configured for determining the mood by analyzing the sensor signal from the sensor system. The control system is configured to set the environmental condition provided by the component dependent on the determined mood.

In accordance with an added feature of the invention, the sensor system is configured for sensing at least one physical property of a plurality of occupants in the vehicle; and the control system is configured for determining the mood of the plurality of occupants in the vehicle by analyzing the sensor signal and for setting the environment condition in the vehicle dependent on the determined moods of the plurality of occupants in the vehicle.

In accordance with an additional feature of the invention, the sensor system is configured for sensing the at least one physical property of a plurality of occupants in the vehicle; and the control system is configured for determining the mood of the plurality of occupants in the vehicle by analyzing the sensor signal and for setting the environment condition in the vehicle dependent on an average of the determined moods of the plurality of occupants in the vehicle. In this way, the environmental condition can be set in a way that would be most beneficial to the occupants as a group.

In accordance with another feature of the invention, a plurality of components are configured in the vehicle. These components are for providing a plurality of environmental conditions in the vehicle. The control system is configured to set the plurality of environmental conditions in the vehicle by controlling the plurality of components dependent on the determined mood. The previously mentioned at least one component should be considered to be one of the plurality of components. Because of this, when the terms “plurality of components” are used, it should be understood that the “at least one component” is in fact one of the plurality of components.

In accordance with a further feature of the invention, the plurality of components includes a vehicle sound system, a vehicle interior lighting system, a vehicle climate control system, and/or an aroma generator.

In accordance with a further added feature of the invention, the control system is configured to cause a navigation system to suggest a route to a desired destination dependent on the determined mood. In this way, the environment around the vehicle can be set in dependence on the determined mood or moods by using the data from the navigation system to select a preferred route through which the vehicle will travel.

In accordance with a further additional feature of the invention, the controller is configured to actuate a safety device to limit the maximum speed of the vehicle dependent on the determined mood.

With the foregoing and other objects in view there is provided, in accordance with the invention, a method for setting at least one environmental condition in or around a vehicle in response to a mood, the method includes steps of: configuring at least one component in the vehicle for providing an environmental condition in the vehicle; sensing, with a sensor system, at least one physical property indicative of a mood of at least one occupant in the vehicle and outputting, from the sensor system, a sensor signal with information regarding the at least one physical property; determining the mood by analyzing the sensor signal with a control system; and setting the environmental condition provided by the component by controlling the component with the control system in a manner dependent on the determined mood.

In accordance with an added mode of the invention, the method includes steps of: sensing, with the sensor system, at least one physical property of a plurality of occupants in the vehicle; determining the moods of a plurality of occupants in the vehicle by analyzing the sensor signal with the control system; and setting the environmental condition provided by the component by controlling the component with the control system dependent on the determined moods of the plurality of occupants.

In accordance with an additional mode of the invention, the method includes steps of: sensing, with the sensor system, at least one physical property of a plurality of occupants in the vehicle; determining a mood of a plurality of occupants in the vehicle by analyzing the sensor signal with the control system; and setting the plurality of environmental conditions in the vehicle by controlling the plurality of components with the control system dependent on an average of the determined moods of the plurality of occupants in the vehicle.

In accordance with another mode of the invention, the method includes steps of: configuring a plurality of components in the vehicle for providing a plurality of environmental conditions in the vehicle; and setting the plurality of environmental conditions in the vehicle by controlling the plurality of components with the control system dependent on the determined mood. The component is one of the plurality of components.

In accordance with a further mode of the invention, the component is a vehicle sound system, a vehicle interior lighting system, a vehicle climate control system, or an aroma generator.

In accordance with a further mode of the invention, the method includes using a navigation system to suggest a particular route to a desired destination dependent on the determined mood.

In accordance with a further added mode of the invention, the method includes using a safety device to limit a maximum speed of the vehicle dependent on the determined mood, which is in particular, the mood of the driver.

Other features which are considered as characteristic for the invention are set forth in the appended claims.

Although the invention is illustrated and described herein as embodied in a system and method for setting an environmental condition in or around a vehicle in response to a determined mood, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE SEVERAL VIEWS OF THE DRAWING

FIG. 1 is a block diagram of a system for setting one or more environmental conditions in or around a vehicle;

FIG. 2 is a diagram showing multiple examples for implementing the sensor system; and

FIG. 3 is a flow chart showing the steps of a method.

### DESCRIPTION OF THE PREFERRED EMBODIMENTS OF THE INVENTION

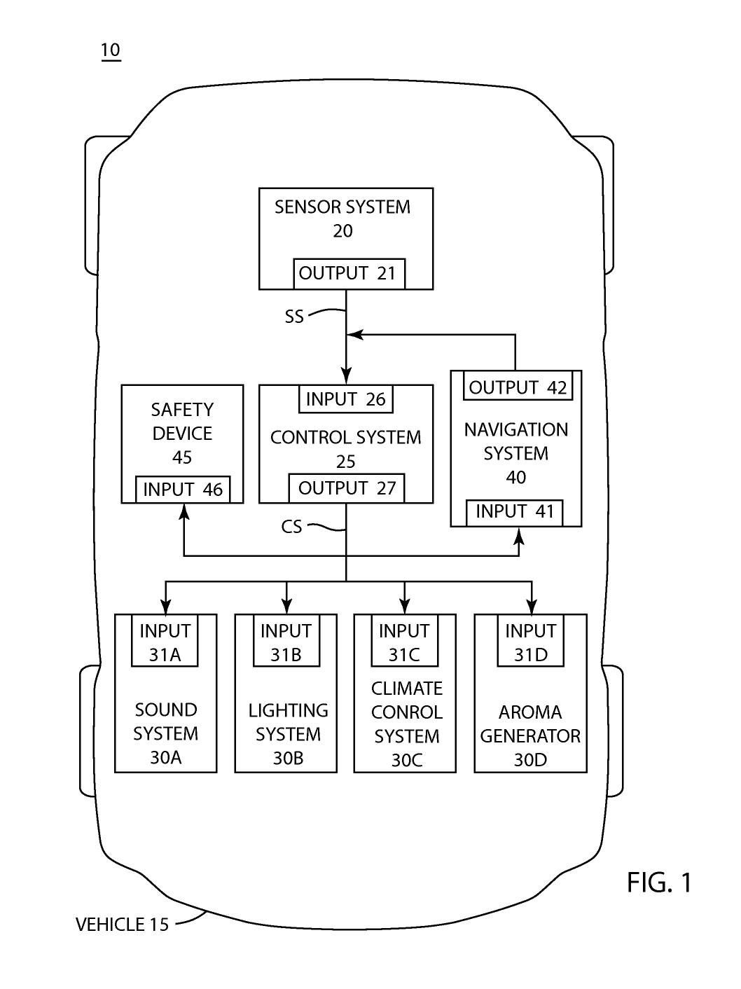

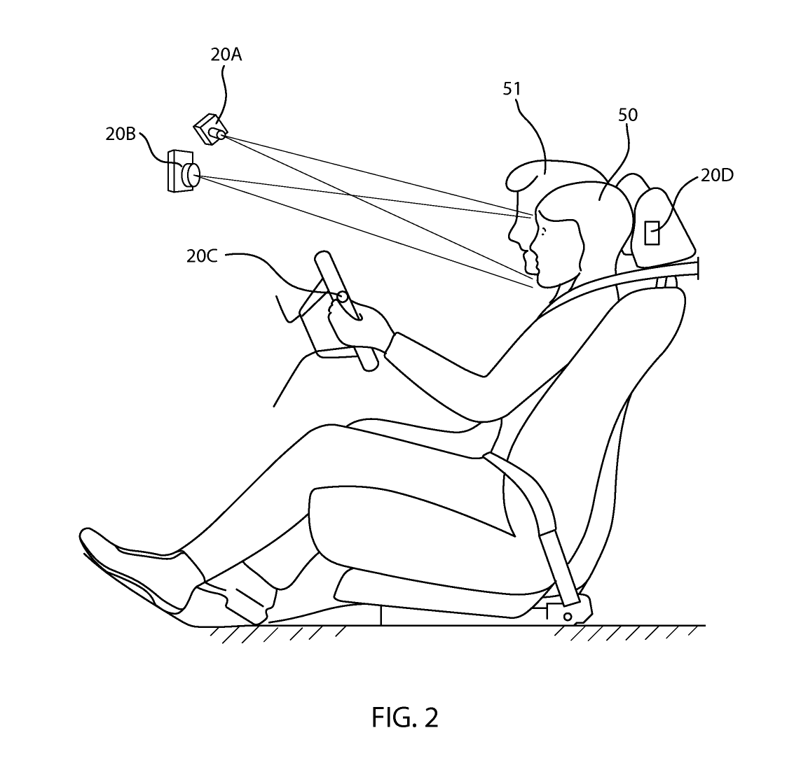

Referring now to the figures of the drawing in detail and first, particularly to FIG. 1 thereof, there is shown a block diagram of a system 10 for setting one or more environmental conditions in or around a vehicle 15 in response to a determined mood of an occupant 50 (not shown in FIG. 1; see FIG. 2) or in response to the determined moods of multiple occupants 50, 51 (see FIG. 2) in the vehicle 15. Generally, when implementing the invention in a private automobile, it is preferable to set one or more environmental conditions in or around the vehicle 15 in response to the determined mood of only one occupant 50, specifically, the driver of the vehicle. When implementing the invention in a commercial vehicle 15, for example, a bus or a taxi cab carrying multiple occupants, it is preferable to set one or more environmental conditions in or around the vehicle 15 in response to the determined moods of multiple occupants 50, 51 in the vehicle 15. However, where there are safety concerns because of the mood of the driver, the mood of the driver would be used to actuate or influence certain safety functions (i.e. safety device 45).

Also, in the context of the invention, the term occupants 50, 51 typically refers to human occupants. However, the invention could also be used with an occupant that is an animal.

The vehicle 15 can be any vehicle that can transport occupants 50, 51 on land, on or in the water, or in the air. However, the vehicle 15 is preferably an automobile, pickup truck, bus, limousine, camper, semi-tractor trailer, or any similar vehicle that travels on land. The system 10 is configured in the vehicle 15 and includes a sensor system 20, a control system 25, and one or more components 30A, 30B, 30C, 30D that are each configured for providing one or more environmental conditions in a vehicle 15. Examples of such components include the vehicle sound system 30A, the vehicle interior lighting system 30B, the vehicle climate control system 30C, and an aroma generator 30D located in the vehicle. The aroma generator 30D could be a simple scent dispenser that is actuated by the control system 25. The system 10 may optionally also include a Global Positioning System (GPS) Navigation System 40 and/or a safety device 45.

The connections between the sensor system 20 and the control system 25, and between the control system 25 and the vehicle sound system 30A, the vehicle interior lighting system 30B, the vehicle climate control system 30C, the aroma generator 30D, the GPS Navigation System 40, the safety device 45, and any other devices can be implemented using a wireless communication system, for example, a communication system using Bluetooth™ technology owned by Bluetooth SIG, or those connections can be hard wired. The only important aspect is that signals and/or data are reliably communicated.

The sensor system 20 is configured for sensing one or more physical properties indicative of the moods of the occupants 50, 51 in the vehicle 15 and for outputting a sensor signal SS indicating the physical property or properties that have been sensed. The sensor system 20 can be constructed to sense one or more physical properties indicative of a mood from only one occupant 50, such as, the driver of the vehicle. Alternatively the sensor system 20 can be constructed to sense one or more physical properties indicative of a mood from multiple occupants 50, 51 in the vehicle. In this case, the sensor signal SS indicates the one or more physical properties that have been sensed from each one of the multiple occupants 50, 51. The sensor system 20 outputs the sensor signal SS at its output 21. The sensor system 20 will be discussed in more detail further below.

The control system 18 could be formed by any known computing device, for example, a microprocessor along with memory and any other needed supporting devices. The input 26 of the control system 25 is electrically or wirelessly connected to the output 21 of the sensor system 20 to receive the sensor signal SS from the sensor system 20. The control system 25 is configured or programmed to determine the mood of at least one occupant 50, 51 in the vehicle 15 by analyzing the sensor signal SS from the sensor system 20. Preferably, the mood that is determined is for the occupant 50 that is the driver of the vehicle 15. However, the occupant 51 could also be any passenger in the vehicle 15. The control system 25 can be configured or programmed to take into account the sensed moods of all of the occupants 50, 51 to determine a mood representing the overall mood of the vehicle 15 in the case where the sensor system 20 is appropriately configured to output a sensor signal SS with information indicating one or more physical properties sensed from multiple occupants in the vehicle 15, and when there are multiple occupants in the vehicle 15. An easy way of determining the overall mood of the vehicle 15 is simply for the control system 25 to take an average value of the determined moods of multiple occupants 50, 51 in the vehicle 15. However, the control system 25 could give more weight to the mood of the occupant 50, whom is the driver, than the moods of the other occupants 51 when determining the overall mood. For example, it might be advantageous give the mood of the driver more weight or the entire weight when the mood of the driver is determined to be extremely angry or sad.

The control system 25 can be configured or programmed to determine many different type of moods from the physical properties sensed by the sensor system 20. A non-limiting list of moods that can be determined include happy, sad, angry, and sleepy. Certainly other moods can be determined in addition to or alternatively to those mentioned. The control system 25 can be configured or programmed to subsequently control one or more environmental conditions provided by the vehicle sound system 30A, the vehicle interior lighting system 30B, the vehicle climate control system 30C, the aroma generator 30D, and/or any other component for providing environmental conditions in the vehicle 15. As mentioned, the control system 25 will control those environmental conditions in a manner dependent on the mood that has been determined by the control system 25.

Once the control system 25 determines the mood of an occupant 50 or the moods of multiple occupants 50, 51 in the vehicle 15, the control system 25 determines how the environmental conditions in or around the vehicle 15 should be controlled based on the determined mood or moods. Examples of such environmental conditions include, but are not limited to: the color and intensity of the interior lighting provided by the vehicle interior lighting system 30B in the vehicle 15, the type of music played by the vehicle sound system 30A, the sound level or loudness of the music played by the vehicle sound system 30A, the interior temperature provided by the vehicle climate control system 30C in the vehicle 15, and/or an aroma being emitted by an aroma generator 30D in the vehicle 15. Any environmental condition that can be sensed by one of the occupants 50, 51 in the vehicle 15 and that can be controlled or influenced by a component in the vehicle 15 can be set in dependence on the determined mood or moods of one or more of the occupants 50, 51 in the vehicle 15. All such environmental conditions should be considered to be within the scope of the invention.

It is known that the environment around a person can influence the mood of that person. For example, certain types of music are calming whereas others are arousing and others will make a person somber. Certainly a relatively lower volume or intensity of music will be more calming when compared to a very high volume or intensity of music.

Also the science of color psychology is well established and it is well known that colors effect human moods. Certain colors, such as blue, green, and pink are known to be calming, while others, such as, red are known to be stimulating. Yellow increases attention, but can cause eye strain. Color temperature has also been shown to effect moods. See Igor Knez, Effects of Indoor Lighting on Mood and Cognition in the Journal of Environmental Psychology, Volume 15, Issue 1, March 1995, pages 39-51.

It is also known that the ambient temperature can influence moods and behavior. For example, it has been found that violent behavior increases during the hottest whether when people are exposed to much hotter than normal temperatures.

As an example, in the case where control system 25 determines that the mood or moods are angry, the control system 25 can output a control signal CS to the input 31A of the vehicle sound system 30A to play calming music at a relatively lower volume or intensity. In that case, the control system 25 can also output a control signal CS to the input 31B of the vehicle interior lighting system 30B to cause the vehicle interior lighting system 30B to illuminate the interior of the vehicle with blue, green, or pink lighting. Additionally, the control system 25 can output a control signal CS to the input 31C of the vehicle climate control system 30C to set the temperature to a relatively cooler temperature. In another option, the control system 25 can output a control signal CS to the input 31D of the aroma generator 30D to cause the aroma generator 30D to emit a calming aroma, such as lavender.

FIG. 2 is a diagram showing multiple examples for implementing the sensor system 20. A plurality of occupants 50, 51 are located in the vehicle 15. One occupant 50 is the driver and another occupant 51 is a passenger. The sensor system 20 can be formed by providing a single sensor for each occupant 50, 51 or it can be formed by providing multiple sensors for each occupant 50, 51.

Several different ways are shown in which one or more physical properties indicative of the mood of the occupant 50 can be sensed. The different types of sensors can be combined, but they do not necessarily have to be combined. In fact, in many applications it is preferable to limit the types of sensors used in the sensor system 20 for reasons of cost.

As a first example, the sensor system 20 can include one or more far infrared sensors 20A that can detect the blood pressure in the face of the occupant 50. In this case, the control system 25 can assign a certain level of the blood pressure to a particular mood. As a second example, the sensor system 20 can include one or more cameras 20B aimed at the face of the occupant 50. In this case, the control system 25 is programmed or configured to implement a face recognition system. The control system 25 can detect certain facial expressions of the occupant 50 and can assign each facial expression with a particular mood. Another option is for the control system 25 to detect a certain frequency of eye blinking of the occupant 50 and to assign a certain level of blinking to a particular mood.

As a third example, the sensor system 20 can include one or more photoplethysmography sensors 20C for detecting vital signs, such as the heart rate and the blood pressure of the occupant 50. In this case, the control system 25 can assign a certain heart rate, blood pressure, or combination of the two with a particular mood. As a fourth example, the sensor system 20 can include EEG sensors 20D on or in the head-rest. The EEG sensors 20D sense the EEG activity of the occupant 50. In this case, the control system 25 is programmed or configured to determine the mood of the occupant 50 based on the EEG activity of the occupant 50. Published U.S. Patent Application Publication 2012/0130196 A1 to Jain et al., the disclosure of which is hereby incorporated by reference, discloses an example of a system that uses a sensor for determining the mood of a person.

When the GPS Navigation System 40 is provided, the input 41 of GPS Navigation System 40 is wirelessly or electrically connected to the output 27 of the control system 25 and the output 42 of the GPS Navigation System 40 is wirelessly or electrically connected to the input 26 of the control system 25. Once an occupant 50, 51 enters the desired destination into the GPS Navigation System 40, the GPS Navigation System 40 sends the current location and the desired destination to the control system 25. The control system 25 then uses the current location, the desired destination, and the determined mood or moods can be used to ascertain one or more optimum routes to the desired destination in dependence on the determined mood or moods. The control system 25 then outputs the optimum route or routes to the GPS Navigation System 40 and the GPS Navigation System 40 shows the optimum route or routes on its display as suggested route(s). The suggested route or one of the suggested routes being displayed can be chosen by an occupant 50, 51 in the vehicle 15 as the route of travel. If the system 10 is implemented in a self-driving vehicle, the optimum route could be automatically selected. When the optimum route is selected and the vehicle 15 actually travels through the optimum route, the determined mood or moods in effect has been used to set the environmental conditions around the vehicle 15.

For example, if the determined mood of one occupant 50 or of a plurality of occupants 50, 51 in the vehicle 15 is angry, the control system 25 can suggest or choose a route with less traffic by using data from the GPS Navigation System 40. As another example, if the determined mood is sad, the control system 25 can suggest or choose a route with more visually pleasing scenery by using data from the GPS Navigation System 40. If the determined mood of the driver is a mood that is susceptible to sleepiness, the control system 25 can suggest a route that is very well lit or that avoids long stretches of highway without stops in order to assist the driver in staying awake. If the determined mood is happy, the control system 25 can suggest or choose the most direct or the fastest route given the current traffic so that the vehicle will arrive at the desired location in the least amount of time. Certainly, with the benefit of the material disclosed herein, it should now be apparent to those of ordinary skill in the art that many other routes could be chosen or suggested in dependence on the determined mood(s). These other mood-dependent routes should be considered to be within the scope of the invention.

The control system 25 can be programmed or configured to actuate a safety device 45 in the vehicle 15 dependent on the determined mood of at least one occupant 50 in the vehicle. The control signal CS is output with the appropriate actuating instructions to the input 46 of the safety device 45 to actuate the safety device 45. Preferably, such a safety device 45 would be configured to limit the maximum speed of the vehicle dependent on the determined mood of the driver. Focusing on the drivers mood driver's is preferable because the mood of the driver could endanger the other occupants as well as the vehicle. If the control system 25 determines that the mood of the driver is too angry or perhaps too sad, the control system 25 will actuate the safety device 45 to limit the maximum speed of the vehicle to a safe speed.

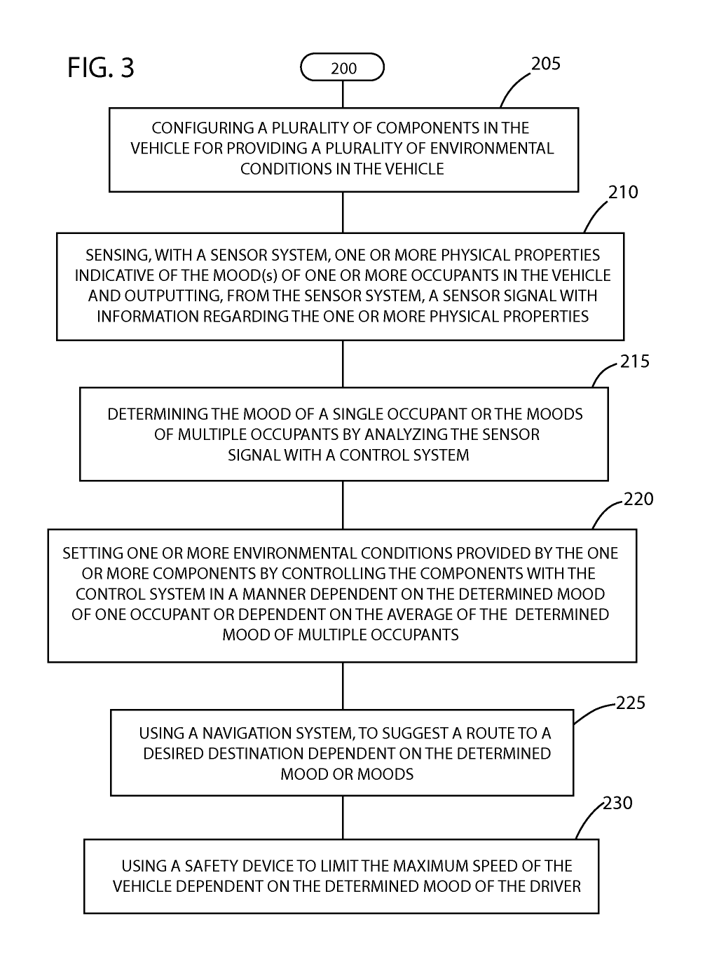

FIG. 3 is a flow chart showing the steps of a method 200 for setting at least one environmental condition in a vehicle in response to a sensed mood. The method 200 includes a step 205 of configuring a plurality of components in the vehicle for providing a plurality of environmental conditions in the vehicle. These components can include, among others, a vehicle sound system, a vehicle interior lighting system, a vehicle climate control system, a global positioning system, and an aroma generator. The next step 210 is sensing, with a sensor system, one or more physical properties indicative of the mood(s) of one or more occupants in the vehicle and outputting, from the sensor system, a sensor signal with information regarding the one or more physical properties. The next step 215 is determining the mood of a single occupant or the moods of multiple occupants by analyzing the sensor signal with a control system. The next step 220 is setting one or more environmental conditions provided by one or more components by controlling the components with the control system in a manner dependent on the determined mood of one occupant or dependent on the average of the determined moods of multiple occupants. The next step 225, which is optional, includes using a navigation system, to suggest a route to a desired destination dependent on the determined mood or moods. The next step 230, which is also optional, includes using a safety device to limit the maximum speed of the vehicle dependent on the determined mood of the occupant functioning as the driver of the vehicle. This step focuses on the driver since the driver's mood could endanger the other occupants as well as the vehicle.

Now that the important features of the invention have been explained, it should be apparent to the person of ordinary skill in the art that numerous variants are possible. Thus, it should be understood that the invention is not limited to the specific examples discussed herein.

I claim:

1. A system for setting at least one environmental condition in or around a vehicle in response to a mood, comprising:
a sensor system configured for sensing at least one physical property indicative of a mood of at least one occupant in a vehicle and for outputting a sensor signal with information regarding the at least one physical property;
at least one component configured for providing an environmental condition in the vehicle; and
a control system configured for determining the mood by analyzing the sensor signal from said sensor system, said control system configured to set the environmental condition provided by said component dependent on the determined mood.

2. The system according to claim 1, wherein:
said sensor system is configured for sensing the at least one physical property of a plurality of occupants in the vehicle; and
said control system is configured for determining a mood of the plurality of occupants in the vehicle by analyzing the sensor signal and for setting the environment condition in the vehicle dependent on the determined moods of the plurality of occupants in the vehicle.

3. The system according to claim 1, wherein:
said sensor system is configured for sensing the at least one physical property of a plurality of occupants in the vehicle; and
said control system is configured for determining the mood of the plurality of occupants in the vehicle by analyzing the sensor signal and for setting the environment condition in the vehicle dependent on an average of the determined moods of the plurality of occupants in the vehicle.

4. The system according to claim 1, further comprising:
a plurality of components configured for providing a plurality of environmental conditions in the vehicle;
said control system configured to set the plurality of environmental conditions in the vehicle by controlling the plurality of components dependent on the determined mood; and
said component being one of said plurality of components.

5. The system according to claim 1, wherein said component is selected from the group consisting of a vehicle sound system, a vehicle interior lighting system, a vehicle climate control system, and an aroma generator.

6. The system according to claim 1, wherein said component is a vehicle interior lighting system.

7. The system according to claim 1, wherein said component is a vehicle climate control system.

8. The system according to claim 1, further comprising: a navigation system, and said control system is configured to cause said navigation system to suggest a route to a desired destination dependent on the determined mood.

9. The system according to claim 1, further comprising: a safety device configured to limit a maximum speed of the vehicle, wherein said controller is configured to actuate said safety device to limit the maximum speed of the vehicle dependent on the determined mood.

10. A method for setting at least one environmental condition in or around a vehicle in response to a mood, the method which comprises:
configuring at least one component in the vehicle for providing an environmental condition in the vehicle;
sensing, with a sensor system, at least one physical property indicative of a mood of at least one occupant in the vehicle and outputting, from the sensor system, a sensor signal with information regarding the at least one physical property;
determining the mood by analyzing the sensor signal with a control system; and
setting the environmental condition provided by the component by controlling the component with the control system in a manner dependent on the determined mood.

11. The method according to claim 10, which further comprises:
sensing, with the sensor system, at least one physical property of a plurality of occupants in the vehicle;
determining moods of a plurality of occupants in the vehicle by analyzing the sensor signal with the control system; and
setting the environmental condition provided by the component by controlling the component with the control system dependent on the determined moods of the plurality of occupants.

12. The method according to claim 11, which further comprises:
sensing, with the sensor system, at least one physical property of a plurality of occupants in the vehicle;
determining a mood of a plurality of occupants in the vehicle by analyzing the sensor signal with the control system; and
setting the plurality of environmental conditions in the vehicle by controlling the plurality of components with the control system dependent on an average of the determined moods of the plurality of occupants in the vehicle.

13. The method according to claim 10, which further comprises:
configuring a plurality of components in the vehicle for providing a plurality of environmental conditions in the vehicle; and
setting the plurality of environmental conditions in the vehicle by controlling the plurality of components with the control system dependent on the determined mood;
wherein the component is one of the plurality of components.

14. The method according to claim 10, wherein the component is selected from the group consisting of a vehicle sound system, a vehicle interior lighting system, a vehicle climate control system, and an aroma generator.

15. The method according to claim 10, wherein the component is a vehicle interior lighting system.

16. The method according to claim 10, wherein the component is a vehicle climate control system.

17. The method according to claim 10, which further comprises: with a navigation system, suggesting a route to a desired destination dependent on the determined mood.

18. The method according to claim 10, wherein the sensing step includes determining the mood of the driver and which further comprises: with a safety device, limiting a maximum speed of the vehicle dependent on the mood of the driver.
